(19) United States
(12) Patent Application Publication
(10) Pub. No.: US 2004/0186639 A1
(43) Pub. Date: Sep. 23, 2004

(54) Programmable multi-function switch and display

(75) Inventor: Steve Car, High Point, NC (US)

Correspondence Address: WATTS, HOFFMANN, FISHER & HEINKE CO., L.P.A., P.O. Box 99839, Cleveland, OH, 44199-0830, US

(73) Assignee: Volvo Trucks North America, Inc.

(21) Appl. No.: 10/394,692

(22) Filed: Mar. 21, 2003

(51) Int. Cl. G06F 19/00

(52) U.S. Cl. 701/36; 340/425.5

(57) ABSTRACT

A multi-function, programmable switch display unit is used to control vehicle operation parameters in a heavy duty over-the-road truck. Several switch screens, each showing a set of related truck parameters can be selectively displayed on a display screen. A matrix of pressure sensitive switches overlays the display screen with cut-outs through which items on the display screen can be viewed. A display controller receives input from the pressure sensitive switches and maps them to the correct truck function and causes appropriate control actions to be taken.

### TECHNICAL FIELD

The invention concerns generally switches for over-the-highway trucks and in particular a programmable multi-function switch panel for controlling cab and chassis related functions in an over-the-highway truck.

### BACKGROUND OF THE INVENTION

As the number of vehicle control and information systems available in over-the-highway trucks increases, the space available to house the mechanical components connected with those control functions dwindles, making placement and packaging of those items more challenging. In many over-the-highway trucks, the operator accessible areas are overwhelmed with switches and displays, making it inconvenient for the operator to monitor and control various features of the truck.

In addition to the great number of switches and displays that must be available to control the increasing number of vehicle control and information systems, the switches and displays in the cab often require dedicated conductors that route control and system monitoring signals to and from the switches and displays. Pass-through panels between the cab and the engine compartment are becoming crowded and access to the various conductors for repair is difficult. Within the cab, wiring in the dashboard area is also becoming complex and crowded.

### SUMMARY OF THE INVENTION

By providing numerous control screens on a single display for control by the same bank of switches, operator compartment space and control lines can be used more efficiently.

A switching method and apparatus is provided for a vehicle, such as a heavy duty over-the-highway truck, having an operator compartment and at least one control module for controlling vehicle components based on input vehicle function parameters. A display module is located in the operator compartment that includes a display screen for displaying information received from a display controller. The display screen is associated with an array of pressure sensitive switches that are mapped to portions of the display screen. Memory is provided for storing a set of switch screens that convey information about related vehicle function parameters. The display controller provides signals to the display module for selectively displaying one of the set of switch screens, receives signals from the pressure sensitive switches, joins the signals from the pressure sensitive switches to a corresponding mapped vehicle function parameter based on the switch screen currently being displayed, and provides vehicle component control signals to the control module based on the received signals from the pressure sensitive switches. In one embodiment, the array of pressure sensitive switches is a mask that includes a plurality of cut outs through which information on the display screen can be viewed. In one embodiment, each switch screen is stored in a corresponding program module that stores computer executable instructions for receiving input from the pressure sensitive switches and providing appropriate control to vehicle components based on the input.

Devices such as smart cards, memory sticks, EEPROM writers, or wireless computing systems may be used to program the modules. The system may include a security screen that prompts the driver to supply a password to enable the ignition system.

### BRIEF DESCRIPTION OF THE DRAWINGS

FIG. 1 is a schematic of a multi-function switch system for an over-the-highway truck constructed according to an embodiment of the present invention;

FIG. 2 is a perspective exploded view of a portion of the multi-function switch shown in FIG. 1; and

FIGS. 3, 4 and 5 are front views of the multi-function switch shown in FIG. 1.

### DETAILED DESCRIPTION OF THE PREFERRED EMBODIMENTS

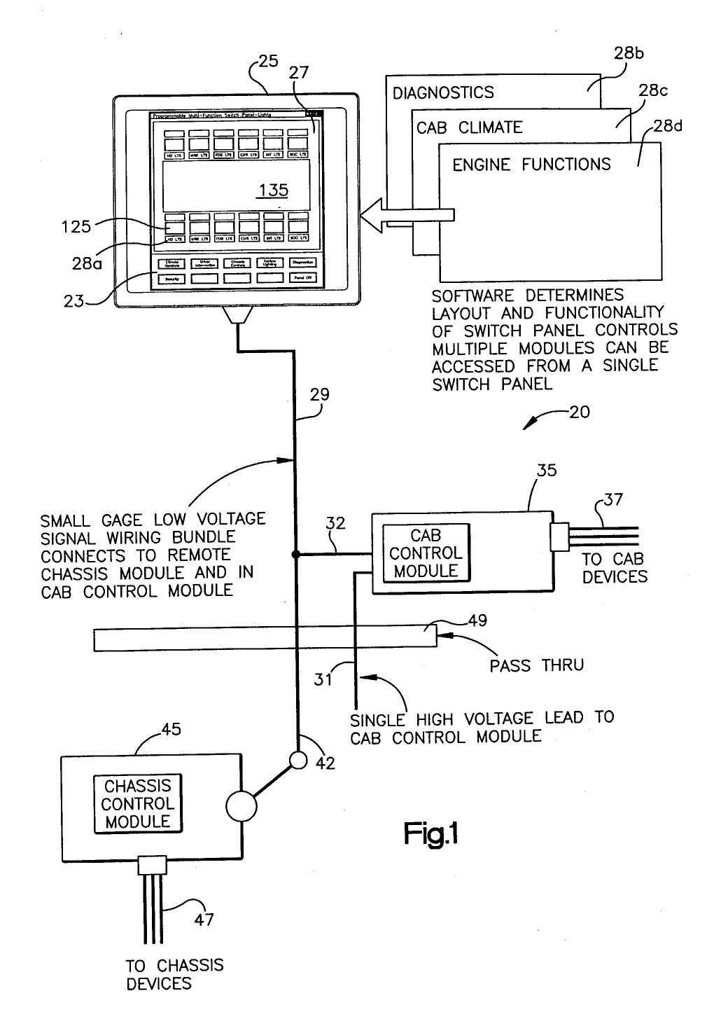

For the purposes of this description, the multi-function switch system will be described in conjunction with an over-the-highway truck, however the switch system may be used in any vehicle having a variety of user controlled parameters. FIG. 1 is a schematic of an overall programmable multi-function switch system for use in an over-the-highway truck. A cab mounted display unit 25 includes a programmable multi-function switch panel 27 for displaying the status of and controlling vehicle functions. The display 25 can be an integral part of the truck instrument panel or can be a separate pod that protrudes from the instrument panel. As will described in greater detail later, a liquid crystal display 135 that displays various sets of vehicle information 28a-28d is overlaid with a matrix of pressure sensitive switches 125 to form the programmable multi-function switch panel. In addition, a set of pressure sensitive switches 23 having fixed operation modes are located below the liquid crystal display portion of the display 25.

A cab control module 35 is also located within the cab to control cab related vehicle functions. The cab module 35 provides signals to the display unit indicative of cab function status as well as control lines via cab control signal wires 32 that tie into a main signal wiring bundle 29. A plurality of dedicated cab signal wires 37 lead from the cab control module to various cab related devices. A single high voltage lead 31 for powering the cab control module 35 protrudes through a pass through panel 49 that separates the cab from the engine compartment. A chassis control module 45 that controls non-cab related functions such as engine, transmission, and suspension components is located in the engine compartment. Like the cab control module, it provides control and status signals to the display module 25 via a bundle of chassis signal wires 42 that runs through the pass through panel and into the main signal wiring bundle 29. A set of chassis control wires 47 connect the chassis control module 45 with various truck devices.

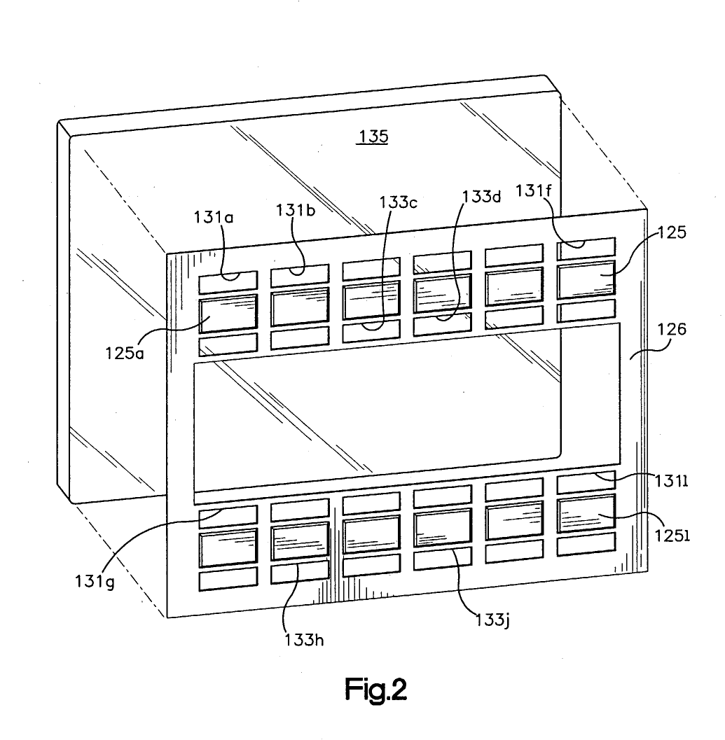

FIG. 2 is an exploded view of the liquid crystal display 135 and an overlying mask 126. The liquid crystal display 135 is adapted to display programmable screens 28a-28d (FIG. 1) that correspond to a user selected function group switch 23. The mask 126 is physically registered to the liquid crystal display so that text and/or characters displayed on the liquid crystal display are visible within windows 131a-131l, 133a-133l, and 135 cut into the mask. Pressure sensitive switches 125a-125l communicate with a controller (not shown) within the programmable multi-function switch panel 27 to control the displayed vehicle functions.

The controller includes a number of programmable control modules or ‘chips’, each associated with a function group switch (FIG. 1). When a function switch is selected, a multiplexer places the corresponding module into communication with the switch panel 27 to display the relevant information and options. When one of control switches is activated to change a setting, the module registers the selection, initiates the appropriate action through a signal to the appropriate control device (such as a relay) and retains the setting in memory until it is changed. When another function group switch is actuated, the current control module stores the current settings prior to the muliplexer connecting the selected function group module to the display. The muliplexer insures that only one function group module is active at any given time.

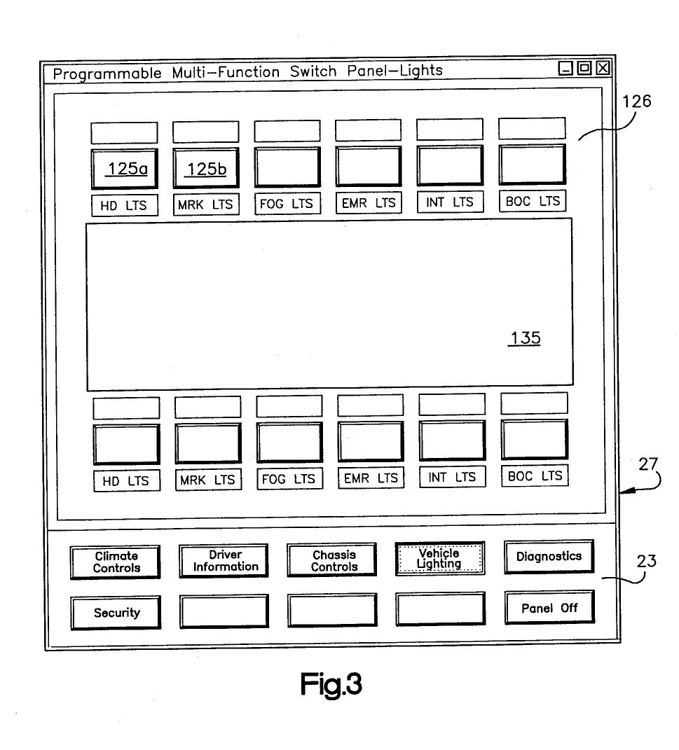

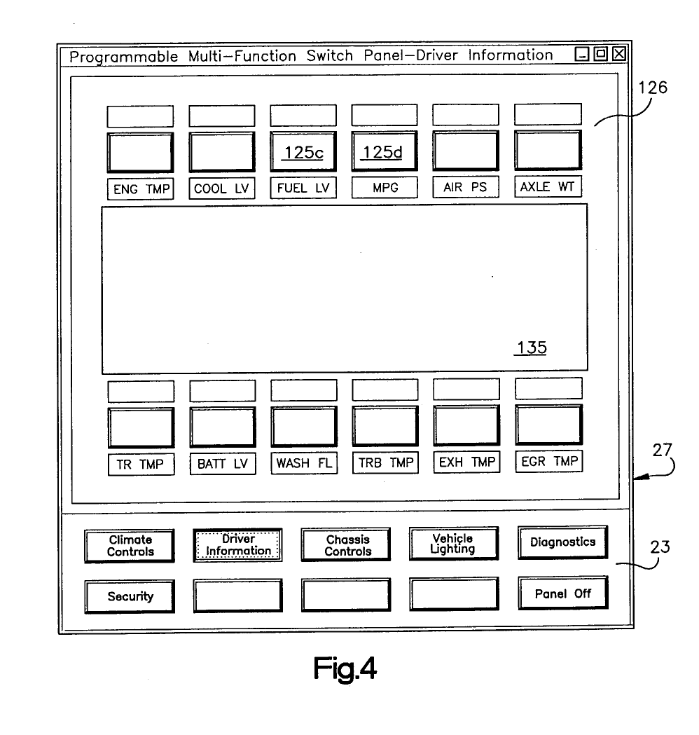

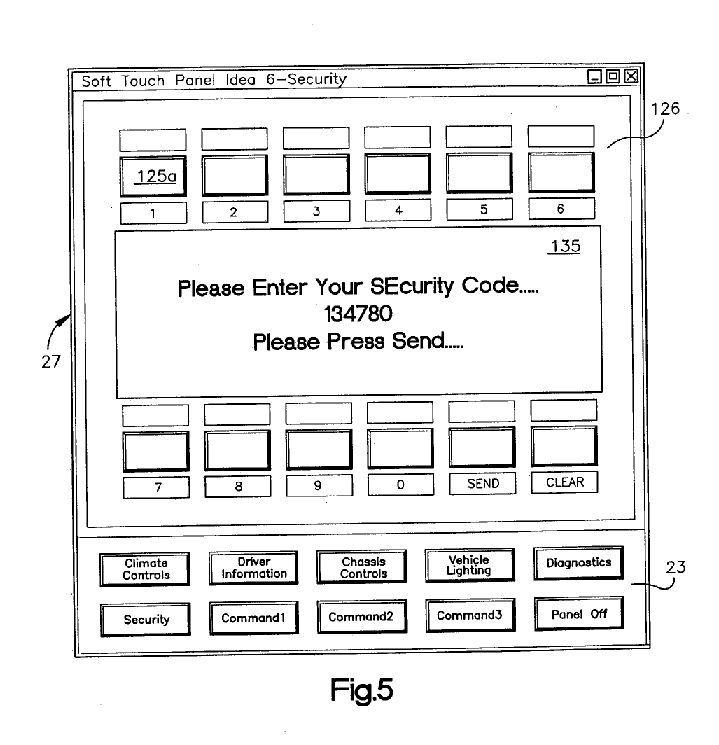

FIGS. 3 and 4 illustrate two versions of the programmable multi-function switch panel 27. In FIG. 3, the “Vehicle Lighting” fixed mode switch 23 has been activated. The liquid crystal display 135 displays a pre-programmed screen that includes labels to show through windows 133a-133l and status information to show through windows 131a-131l for the various control switches 125a-125l. The liquid crystal display may also display a text or graphic message for viewing through the large central window 135. FIG. 4 shows a version of the programmable multi-function switch panel 27 when the “Driver Information” fixed mode switch has been activated. FIG. 5 illustrates the multi-function switch panel in “Security” mode. In this mode, the switch panel prompts the user for a security code, verifies the input code, and enables critical vehicle components such as the engine upon code verification. In a preferred embodiment, the driver would insert a smart card into a smart card reader (not shown) to enable the ignition system when the display panel is in security mode. The smart card would have driver security information such as access codes stored on it.

Prior to installation in a truck, the programmable multi-function switch panel is programmed to display information corresponding to each fixed mode switch 23. The number of functions that can be controlled by using the programmable multi-function switch panel as well as the nature of control is determined when the panel is programmed. Portable memory devices such as memory sticks or smart cards could be used to program the switch panel in the field. Later, the programmable multi-function switch panel can be reprogrammed to reflect updates or other enhancements without requiring the removal of the switch from the vehicle.

Use of the programmable multi-function switch panel reduces the number of wires that must travel through the pass through panel, because only a single high voltage wire is required for the cab control module. The number of pneumatic lines that must travel through the pass through panel is also reduced because some chassis components have control devices that are mounted near them. When separate switches are used to control the various cab functions, numerous high voltage wires are required. In addition, since numerous vehicle functions are monitored and controlled using a single switch panel, valuable instrument panel space is conserved.

In this description the invention has been described with reference to an over-the-highway truck. However, the invention is also applicable to other types of vehicles, in particular heavy duty vehicles that have a variety of driver controlled functions. Such heavy duty vehicles include not only over-the-highway trucks, but off-road vehicles such as construction machines, wheel loaders, articulated haulers, excavators.

The preferred embodiments of the invention have been illustrated and described in detail. However, the present invention is not to be considered limited to the precise construction disclosed. Various adaptations, modifications and uses of the invention may occur to those skilled in the art to which the invention relates and the intention is to cover hereby all such adaptations, modifications, and uses which fall within the spirit or scope of the appended claims.

What is claimed is:

1. A switch apparatus for a vehicle wherein the vehicle comprises an operator compartment and at least one control module for controlling vehicle components based on input vehicle function parameters, the switch apparatus comprising:
a display module located in the operator compartment comprising a display screen for displaying information received from a display controller wherein the display screen is associated with an array of pressure sensitive switches that are mapped to portions of the display screen;
wherein the display controller comprises memory for storing a set of switch screens comprising information about related vehicle function parameters and wherein the display controller provides signals to the display module for selectively displaying one of the set of switch screens, receives signals from the pressure sensitive switches, joins the signals from the pressure sensitive switches to a corresponding mapped vehicle function parameter based on the switch screen currently being displayed, and provides vehicle component control signals to the control module based on the received signals from the pressure sensitive switches.

2. The switch apparatus of claim 1 wherein at least one of the pressure sensitive switches is a mode selection switch that provides a signal to the display controller indicative of which switch screen to display on the display screen.

3. The switch apparatus of claim 1 wherein the display control module comprises memory for storing a most recent setting for each vehicle function parameter.

4. The switch apparatus of claim 1 comprising a security switch screen that prompts a user to input a password and wherein the display controller matches the input password to a stored password and provides an enabling signal to a vehicle ignition system when the input password matches the stored password.

5. The switch apparatus of claim 1 wherein the display controller comprises a plurality of function group modules each having stored therein instructions for accepting input from the pressure sensitive switches and performing corresponding control functions in response to the pressure sensitive switch input.

6. The switch apparatus of claim 5 wherein the display controller comprises a multiplexer for selectively placing one of the function group modules in communication with the display screen.

7. The switch apparatus of claim 1 wherein the set of switch screens is stored in the display controller by a portable memory device.

8. The switch apparatus of claim 7 wherein the portable memory device is a memory stick.

9. The switch apparatus of claim 4 wherein the user inputs a password by inserting a smart card into a smart card reader to enable the vehicle ignition system.

10. The switch apparatus of claim 1 wherein the array of pressure sensitive switches is disposed on a switch mask that overlays the display screen and comprises cut out portions through which the display screen may be viewed.

11. For a vehicle comprising an operator compartment and at least one control module for controlling vehicle components based on input vehicle function parameters, a method for controlling the vehicle components based on input vehicle function parameters, comprising the steps of:
storing a plurality of switch screens comprising information about a set of related vehicle function parameters for display on a switch display screen and mapping portions of each display screen to a corresponding vehicle function parameter;
selectively displaying one of the switch screens;
receiving user input signals from an array of pressure sensitive switches that is associated with the switch display screen;
joining the received user input signals with the corresponding mapped vehicle function parameter based on the selected switch screen; and
providing vehicle component control signals to the control module based on the user input signals.

12. The method of claim 11 comprising the step of receiving a user input selection signal to determine which switch screen is to be displayed.

13. The method of claim 11 comprising the step of storing most recent input values for each vehicle function parameter.

14. The method of claim 11 comprising the steps of storing a security password, prompting a user to input a password, comparing the stored password with the input password, and enabling an ignition system upon receipt of an input password that matches the stored password.

15. The method of claim 11 wherein the step of storing a plurality of switch screens is performed by storing, on a separate module for a given set of related vehicle function parameters, computer executable instructions for displaying vehicle function parameter settings and options, receiving input from the pressure sensitive switches, and controlling corresponding vehicle function parameters in response to the input.

16. The method of claim 15 wherein the step of selectively displaying one of the switch screens is performed by a multiplexer that enables a selected module in response to a user input.

17. A vehicle comprising:
an operator compartment;
at least one control module for controlling vehicle components based on input vehicle function parameters; and
a switch apparatus comprising a display module located in the operator compartment comprising a display screen for displaying information received from a display controller wherein the display screen is associated with an array of pressure sensitive switches that are mapped to portions of the display screen; and
wherein the display controller comprises memory for storing a set of switch screens comprising information about related vehicle function parameters and wherein the display controller provides signals to the display module for selectively displaying one of the set of switch screens, receives signals from the pressure sensitive switches, joins the signals from the pressure sensitive switches to a corresponding mapped vehicle function parameter based on the switch screen currently being displayed, and provides vehicle component control signals to the control module based on the received signals from the pressure sensitive switches.

18. The vehicle of claim 17 wherein at least one of the pressure sensitive switches is a mode selection switch that provides a signal to the display controller indicative of which switch screen to display on the display screen.

19. The vehicle of claim 17 wherein the display control module comprises memory for storing a most recent setting for each vehicle function parameter.

20. The vehicle of claim 17 comprising a security switch screen that prompts a user to input a password and wherein the display controller matches the input password to a stored password and provides an enabling signal to a vehicle ignition system when the input password matches the stored password.

21. The vehicle of claim 17 wherein the display controller comprises a plurality of function group modules each having stored therein instructions for accepting input from the pressure sensitive switches and performing corresponding control functions in response to the pressure sensitive switch input.

22. The vehicle of claim 21 wherein the display controller comprises a multiplexer for selectively placing one of the function group modules in communication with the display screen.

23. The vehicle of claim 17 wherein the array of pressure sensitive switches is disposed on a switch mask that overlays the display screen and comprises cut out portions through which the display screen may be viewed.
